(19) United States
(12) Patent Application Publication
(10) Pub. No.: US 2008/0068175 A1
(43) Pub. Date: Mar. 20, 2008

(54) Antenna Arrangements for Radio Frequency Identification (RFID) Tags

(75) Inventors: Theodore HOCKEY, Mount Airy, MD (US); Joseph White, Woodbine, MD (US); Michael Sloan, Ellicott City, MD (US); Hai Tran, Aldie, VA (US); Wayne E. Shanks, Baltimore, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/855,758

(22) Filed: Sep. 14, 2007

Related U.S. Application Data
(60) Provisional application No. 60/844,367, filed on Sep. 14, 2006.

(51) Int. Cl. G08B 13/14

(52) U.S. Cl. 340/572.7

(57) ABSTRACT

Various antenna arrangements are disclosed for RFID tags. Embodiments of single dipole, dual dipole and patch antenna arrangements are described. Dipole antenna arrangements include metalizations used for tuning the antenna to resonance and for impedance matching to an IC with which they operate. Patch antenna arrangements have cut out portions used for tuning the antenna to resonance and for impedance matching to an IC with which they operate.

### CROSS-REFERENCE TO RELATED APPLICATION

This application claims the benefit of the U.S. Provisional Application 60/844,367 filed on Sep. 14, 2006, entitled ANTENNA DESIGNS FOR RADIO FREQUENCY IDENTIFICATION (RFID) TAGS, the entire contents of which is incorporated by reference and for which priority is claimed under 35 U.S.C. §119(e).

### BACKGROUND OF THE INVENTION

The present invention relates to antennas for radio frequency identification (RFID) tags.

Radio frequency identification (RFID) tags are electronic devices that may be affixed to items whose presence is to be detected and/or monitored. The presence of an RFID tag, and therefore the presence of the item to which the tag is affixed, may be checked and monitored by devices known as “readers.” Readers typically transmit radio frequency signals to which the tags respond.

Each tag can store a unique identification number. The tags respond to the reader-transmitted signals by providing their identification number, bit-by-bit, so that they can be identified.

Antennas integrated into RFID tags present design challenges. In an “ideal world” one could provide a full size dipole or other type of antenna that resonates over a communication channel band on which the RFID tag is to communicate. However, due to size and other constraints design compromise is necessary. Often there is insufficient physical area on an RFID tag substrate on which to provide a full size antenna. Any time an antenna can not be full size (for example ½ wavelength at intended operating frequency for a simple dipole antenna), there are design trade offs related to the size of antenna elements, reactive loading networks to bring resonance to desired frequencies, matching networks to match antenna impedance to a conjugate of the impedance of a driver circuit or receiving circuit, etc.

What is needed are improved antenna configurations for RFID tags that enable increased communication ranges, more reliable communication over desired frequencies, relatively small tag form factors, increased antenna efficiency and decreased RFID tag costs.

### BRIEF SUMMARY OF THE INVENTION

Methods, systems, and apparatuses for antenna configurations for radio frequency identification (RFID) tags are described.

Numerous embodiments of antenna arrangements are described in detail below.

The various advantages and features of each configuration will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a plan view of an exemplary radio frequency identification (RFID) tag.

FIG. 2 shows a plan view of an exemplary web of tags that is a continuous roll type.

FIG. 3A shows an example block diagram of a tag interaction system, according to an embodiment of the present invention.

FIG. 3B schematically illustrates an antenna pattern of dipole antenna.

FIG. 3C schematically illustrates an antenna pattern of an antenna having additional elements demonstrating one design principle of various antenna embodiments set forth herein, namely obtaining a more useful antenna pattern to enhance the efficiency of RFID tag operation.

FIG. 4A shows an example antenna configuration having four dipole elements and associated tuning and matching elements, according to an embodiment of the present invention.

FIG. 4B shows a detailed view of a portion of the antenna of FIG. 4A.

FIG. 5A shows an example antenna configuration having four dipole elements with associated tuning and matching elements, according to an embodiment of the present invention.

FIG. 5B shows a detailed view of a portion of the antenna of FIG. 5A.

FIG. 5C is a perspective view of the antenna element pattern shown in plan view in FIG. 5A.

FIG. 6A shows an example antenna configuration having two dipole elements with associated tuning and matching elements, according to an embodiment of the present invention.

FIG. 6B shows a detailed view of a portion of the antenna of FIG. 6A.

FIG. 7A shows an example of a patch antenna configuration having two slots, according to an embodiment of the present invention.

FIG. 7B shows a detailed view of a portion of the antenna of FIG. 7A.

FIG. 8A shows an example antenna configuration having two arms with “trident” elements on each arm, according to an embodiment of the present invention.

FIG. 8B shows a detailed view of a portion of the antenna of FIG. 8A.

FIG. 9A shows an example antenna configuration having two arms with “trident” elements on each arm, according to an embodiment of the present invention.

FIG. 9B shows a detailed view of a portion of the antenna of FIG. 9A.

FIG. 10A shows an example antenna configuration for a plastic environment, according to an embodiment of the present invention.

FIG. 10B shows a detailed view of a portion of the antenna of FIG. 10A.

FIG. 11 shows an example antenna configuration for a plastic environment, according to an embodiment of the present invention.

FIG. 12A shows an example antenna configuration for a wood environment, according to an embodiment of the present invention.

FIG. 12B shows a detailed view of a portion of the antenna of FIG. 12A.

FIG. 13A shows an example patch antenna configuration, according to an embodiment of the present invention.

FIG. 13B shows a detailed view of a portion of the antenna of FIG. 13A.

FIG. 13C is a schematic diagram of an IC die which transmits/receives signals to/from various of the antenna embodiments.

FIG. 14 shows an example of a patch antenna configuration, according to an embodiment of the present invention.

FIG. 15A shows an example antenna configuration, according to an embodiment of the present invention.

FIG. 15B shows a detailed view of a portion of the antenna of FIG. 15A.

FIG. 16 shows an example layout of a die-mount position, according to an embodiment of the present invention.

FIG. 17A shows an example antenna configuration particularly suited for use in an animal RFID tag, according to an embodiment of the present invention.

FIG. 17B shows a detailed view of a portion of the antenna of FIG. 17A.

FIG. 18A shows an example antenna configuration particularly suited for use in a paper or wood environment, according to an embodiment of the present invention.

FIG. 18B shows a detailed view of a portion of the antenna of FIG. 18A.

FIG. 19A shows an example antenna configuration having four radiating/receiving elements, according to an embodiment of the present invention.

FIG. 19B shows a detailed view of a portion of the antenna of FIG. 19A.

FIG. 20A shows an example antenna configuration having two arms each with a “trident” radiating/receiving element, according to an embodiment of the present invention.

FIG. 20B shows a detailed view of a portion of the antenna of FIG. 20A.

FIG. 21A shows an example antenna configuration particularly suitable for a plastic environment, according to an embodiment of the present invention.

FIG. 21B shows a detailed view of a portion of the antenna of FIG. 21A.

FIG. 22A shows an example antenna configuration particularly suitable for use as a bag tag, such as, for example a luggage tag in an airport baggage handling system, according to an embodiment of the present invention.

FIG. 22B shows a detailed view of a portion of the antenna of FIG. 22A.

The present invention will now be described in terms of specific embodiments which are depicted in the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present invention relates to antenna configurations for radio frequency identification (RFID) tags. According to embodiments of the present invention, a tag has a substrate. One or more antennas are formed in or on the substrate. In an embodiment, the tag has an electrical circuit coupled to the one or more antennas. The electrical circuit uses the antenna to communicate with entities, such as a reader, external to the tag. The electrical circuit may include one or more integrated circuit chips or dies, for example.

It is noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### Example Tag Embodiments

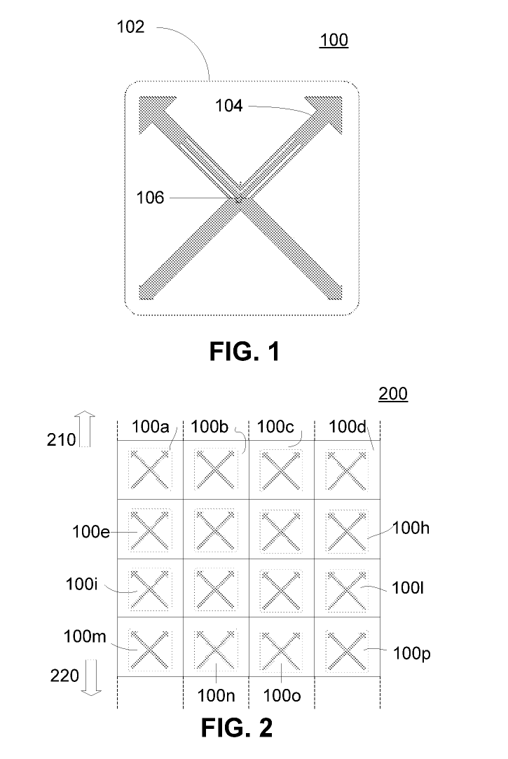

The present invention is applicable to any type of RFID tag. FIG. 1 is a plan view of an example radio frequency identification (RFID) tag 100. Tag 100 has a substrate 102 onto which various other components are integrated including an antenna 104, and an integrated circuit (IC) 106. Antenna 104 is formed on a surface of substrate 102. Antenna 104 may include any number of one or more separate antennas or antenna elements. IC 106 includes one or more integrated circuit chips/dies, and can include other electronic circuitry. IC 106 is attached to substrate 102. Antenna 104 is coupled to one or more ports of IC 106 so that the IC can receive signals from the antenna and drive the antenna as appropriate. IC 106 may be attached to substrate 102 in a recessed and/or non-recessed location. IC 106 controls operation of tag 100, and transmits signals to, and receives signals from RFID readers using antenna 104. Tag 100 may include additional elements, such as, for example, an impedance matching network for antenna 104 and/or other circuitry. The present invention is applicable to tag 100, and to other types of tags, including surface wave acoustic (SAW) type tags, tags that operate on electric fields and tags that operate on magnetic fields.

Antenna 104 can be formed on or in substrate 102 in any suitable manner, including using various conventional techniques. For example, antenna 104 can be printed on substrate 102, including using silk screen printing techniques. Alternatively, antenna 104 can be cast onto substrate 102. In an exemplary embodiment, antenna 104 is attached to substrate 104 using an adhesive material. Antenna 104 can be formed from a variety of materials, including a conductive ink, a metal such as silver, and from other materials.

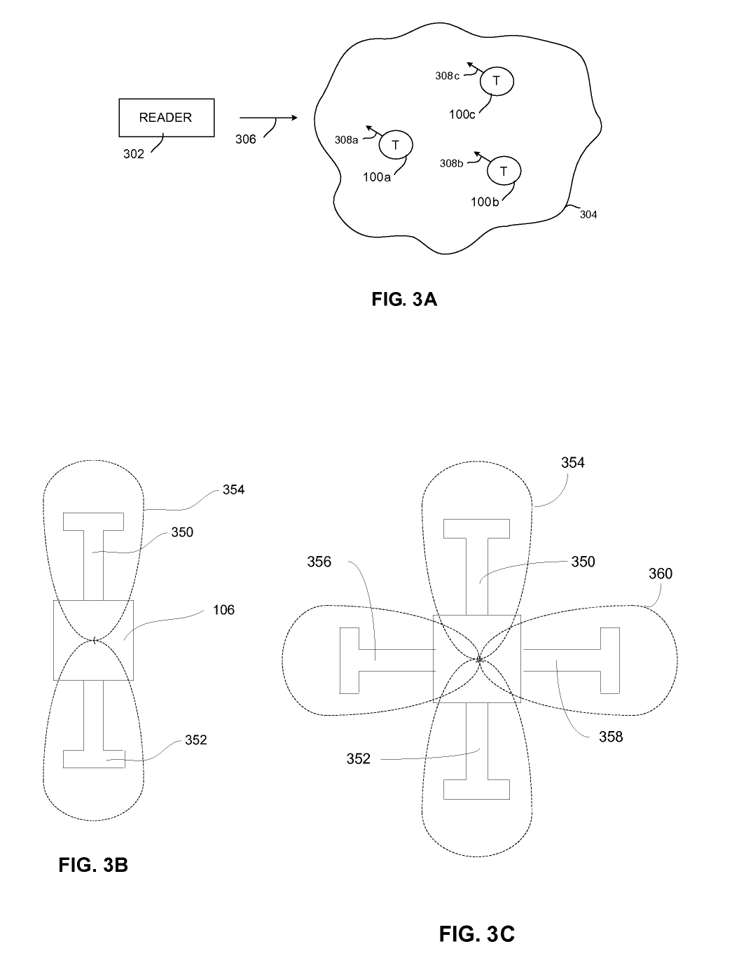

Volume production of RFID tags, such as tag 100, is typically accomplished on a printing web based system. For example, in such a system, the tags are assembled in a web of substrates, which may be a sheet of substrates, a continuous roll of substrates, or other grouping of substrates. For instance, FIG. 2 shows a plan view of an example web 200 that is a continuous roll type. Web 200 may extend further in the directions indicated by arrows 210 and 220. Web 200 includes a plurality of tags 100a-p. In the example of FIG. 2, tags 100a-p in web 200 are arranged in a plurality of rows and columns. The present invention is applicable to any number of rows and columns of tags, and to other arrangements of tags.

Embodiments described herein are applicable to all forms of tags, including tag “inlays” and “labels.” A “tag inlay” or “inlay” is defined as an assembled RFID device that generally includes an integrated circuit chip (and/or other electronic circuit) and antenna formed on a substrate, and is configured to respond to interrogations. A “tag label” or “label” is generally defined as an inlay that has been attached to a pressure sensitive adhesive (PSA) construction, or has been laminated, and cut and stacked for application. One form of a “tag” is a tag inlay that has been attached to another surface, or between surfaces, such as paper, cardboard, etc., for attachment to an object to be tracked, such as an article of clothing, etc.

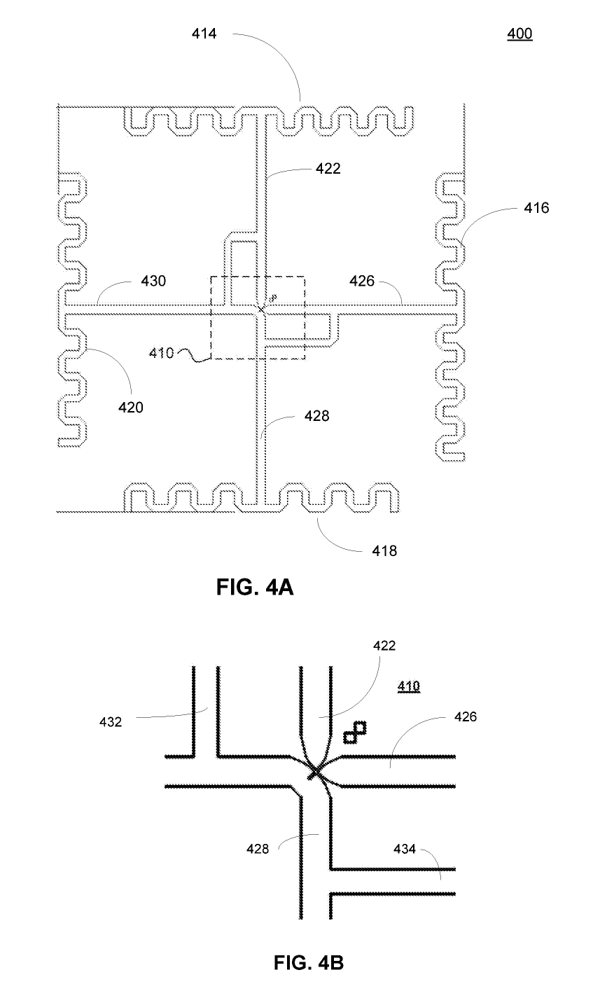

FIG. 3A illustrates an example environment 300 where a RFID reader 302 communicates with an exemplary population 304 of RFID tags 100. The population 304 of tags includes three tags 100a-100a. According to embodiments of the present invention, a population 304 may include any number of tags 100. In some embodiments, a very large number of tags 100 (e.g., hundreds, thousands, or even more) may be included in a population 304 of tags.

Reader 302 may be requested by an external application to address the population of tags 304. Alternatively, reader 302 may have internal logic that initiates communication, or may have a trigger mechanism that an operator of reader 104 uses to initiate communication, such as in a hand-held reader embodiment.

As shown in FIG. 3, reader 302 transmits an interrogation signal 306 having a carrier frequency to the population of tags 304. Reader 302 operates in one or more of the frequency bands allotted for this type of RF communication. For example, frequency bands of 902-928 MHz and 2400-2483.5 MHz have been defined for certain RFID applications by the Federal Communication Commission (FCC). Furthermore, due to regulatory or operational considerations, reader 302 may change carrier frequency on a periodic basis (e.g., ranging from 50 to 400 milliseconds) within the operational band. In these “frequency hopping” systems, the operational band is divided into a plurality of channels. For example, the 902-928 MHz frequency band may be divided into 25 to 50 channels, depending upon the maximum bandwidth defined for each channel. The maximum allowable bandwidth for each channel may be set by local or national regulations. For example, according to FCC Part 15, the maximum allowed bandwidth of a channel in the 902-928 MHz band is 500 kHz. Each channel is approximately centered around a specific frequency, referred to herein as the hopping frequency.

In one embodiment, a frequency hopping reader changes frequencies between hopping frequencies according to a pseudorandom sequence. Each reader 104 typically uses its own pseudorandom sequence. Thus, at any one time, one reader 104 may be using a different carrier frequency than another reader 104 in an environment.

Tags 100 transmit one or more response signals 308 to an interrogating reader 302 in a variety of ways, including by alternatively reflecting and absorbing portions of signal 308 according to a time-based element arrangement or frequency. This technique for alternatively absorbing and reflecting signal 308 is referred to herein as backscatter modulation. Reader 302 receives response signals 308, and obtains data from response signals 308, such as an identification number of the responding tag 100.

An example protocol for communications between RFID tags 100 and reader 302, commonly referred to as Gen-2, is articulated in “EPC™ Radio-Frequency Identity Protocols Class-1 Generation-2 UHF RFID Protocol for Communications at 860 MHz-960 MHz,” Version 1.0.9, and published 2004, which is incorporated by reference herein in its entirety. Embodiments of the present invention are also applicable to further protocols than those described herein, including slotted Aloha protocols, binary traversal type protocols, and standard protocols, such as EPC Class 0 and EPC Class 1.

### Example Antenna Embodiments

FIGS. 3B and 3C schematically demonstrate one design principle of various antenna embodiments set forth herein, namely obtaining a more useful antenna pattern to enhance the efficiency of RFID tag operation. One of the goals of utilizing various patterns of antenna elements is to enhance the antenna transmitting and receiving pattern of an RFID tag. FIG. 3B schematically illustrates an antenna pattern of dipole antenna. FIG. 3C schematically illustrates an antenna pattern of an antenna having additional elements.

FIG. 3B schematically shows an RFID tag having an antenna comprising two dipole elements 350 and 352. The dotted line 354 shows the antenna pattern associated with such a configuration. By adding two additional antenna elements 356 and 358 as shown in FIG. 3C, additional antenna pattern shown by dotted line 360 is added.

Another design principle that contribute to the antenna patterns of the various embodiments including the need to obtain resonance at a desired band of frequencies using antenna elements that have a physical dimension that is less than an “electrical” dimension at a desired frequency.

A further design principle that contribute to the antenna patterns of the various embodiments including the need to provide a conjugate match between the impedance of the antenna and the impedance of the driver/receiver portion of an RFID tag IC.

Example antenna configurations are described below. These example embodiments are provided for illustrative purposes, and are not intended to be limiting. Further embodiments will be apparent to persons skilled in the relevant art(s) from the teachings herein, including modifications, alternatives, combinations, etc. These further embodiments are within the scope and spirit of the present invention.

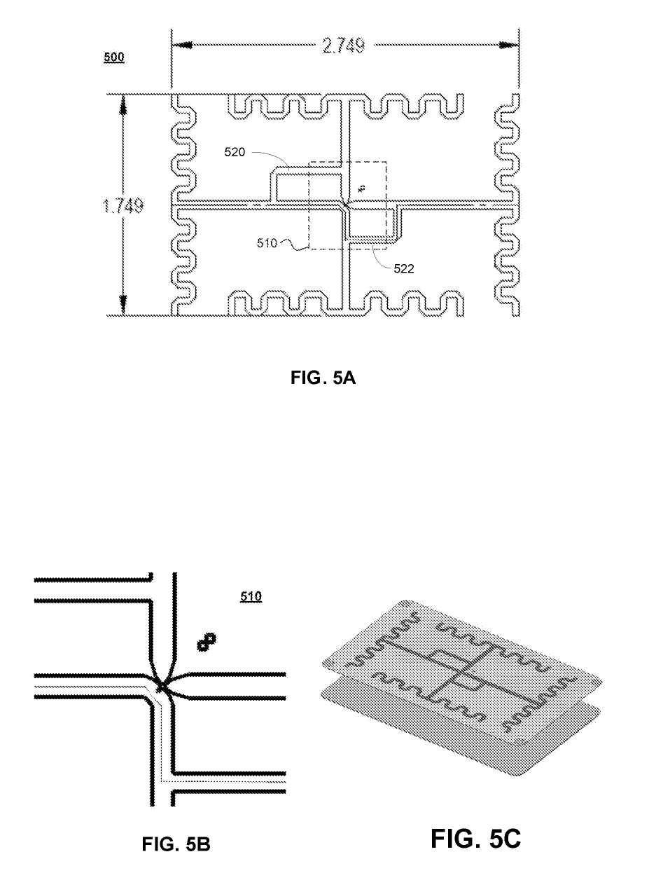

FIG. 4A and FIG. 4B illustrate an antenna element arrangement 400 constituting a dual dipole antenna. FIG. 4B is an enlargement of region 410 shown in FIG. 4A. What appears generally as a central cross-shaped (+ shaped) portion in FIG. 4A is a region of connection points to the RFID tag's IC antenna ports. Dipole antenna elements are formed by metallizations 414, 416, 418 and 420. These antenna elements are coupled to the IC via metalizations 422, 426, 428 and 430, respectively. Metalizations 414, 416, 418 and 420 are constructed and arranged to have an undulating element arrangement. This element arrangement allows the overall length of each of the antenna elements to be physically shorter than its electrical length. The undulating antenna element arrangement has an approximate shape of a sine wave of approximately 7-8 cycles. Antenna element arrangement 400 further includes first and second L-shaped portions 432 and 434. The first L-shape portion 432 connects metalizations 422 and 430. The second L-shape portion 434 connects metalizations 426 and 428. An overall shape of a perimeter of antenna element arrangement 400 is substantially square. Antenna element arrangement 400 may exhibit other shapes.

FIG. 4B shows a detailed view of portion 410. An IC die-mount location is located at the center of portion 410 where metalizations 422, 426, 428 and 430 meet. L-shape portions 432 and 434, together with the other metalizations, act as an impedance matching network, matching the impedance of the RF ports of the IC to the impedance of the antenna elements connected to them.

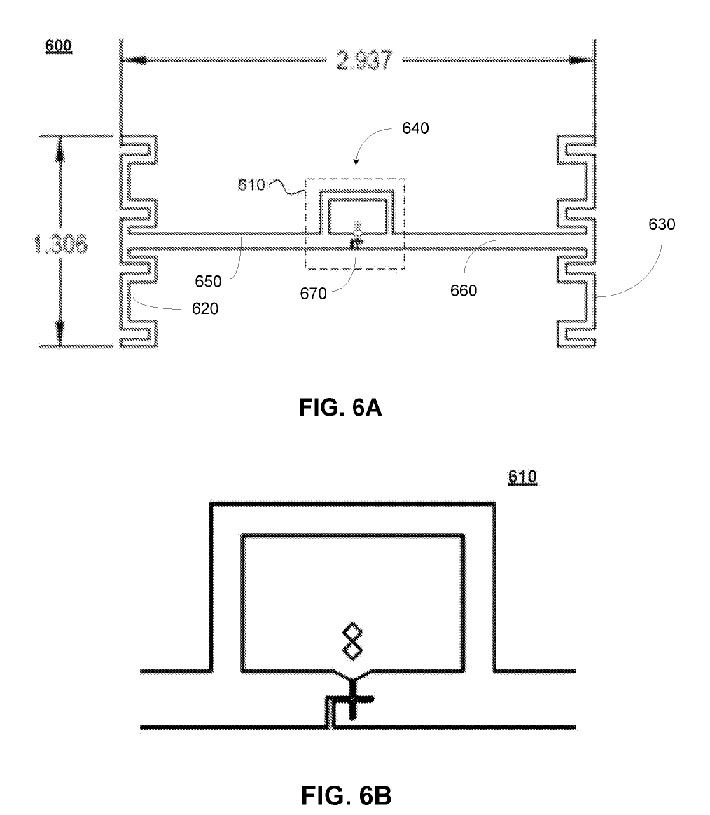

FIG. 5A illustrates an antenna element arrangement 500 that is generally similar to antenna element arrangement 400 of FIG. 4. Antenna element arrangement 500 has an overall rectangular shape. A detailed view of portion 510 is shown in FIG. 5B. Similar to antenna element arrangement 400, an IC die-mount location is also located at the center of portion 510 where the arms of antenna 500 meet. This particular antenna element arrangement is well suited for a so-called ISO card or “credit card” application. It is so-called because its overall dimensions approximate the size of a credit card. It is also known as a “CR-80” antenna. Metalizations 520 and 522 function as matching networks for matching the impedance of the antenna elements to the impedance of the RF ports of the IC.

FIG. 5C is a perspective view of the antenna element pattern shown in plan view in FIG. 5A.

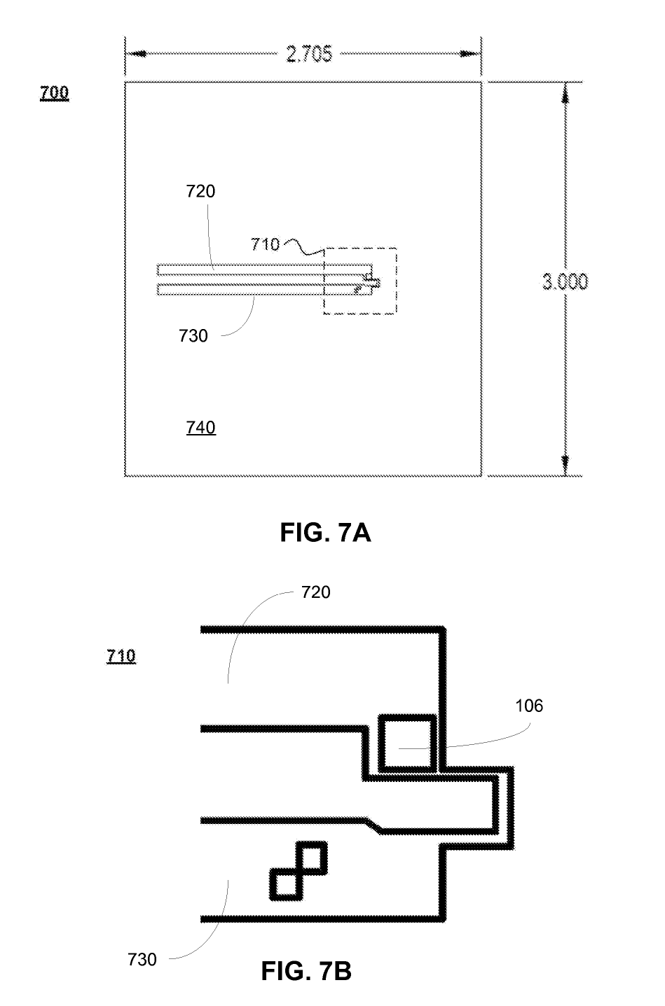

FIG. 6A illustrates an antenna element arrangement 600 of a dual dipole antenna (one dipole at the left side of the figure and one dipole at the right side of the figure) with a central bar-shaped portion having two arms extending away from a central location. Each end of the arms is attached to an undulating antenna element 620 and 630, respectively. Each undulating portion 620 and 630 has approximately 3-4 cycles and has a general shape of a square wave. The electrical length of each dipole is approximately ½ wavelength at the intended operating frequency. However, due to the undulating element arrangement, its physical length is shorter than its electrical length. Antenna element arrangement 600 includes a U-shaped portion 640 that connects two feeder arms 650 and 660 so as to bypass a central location 670. A detailed view of portion 610 is shown in FIG. 6B, which shows a generally cross-shaped junction where an IC die-mount location is formed. The overall dimension of antenna element arrangement 600 is credit card size.

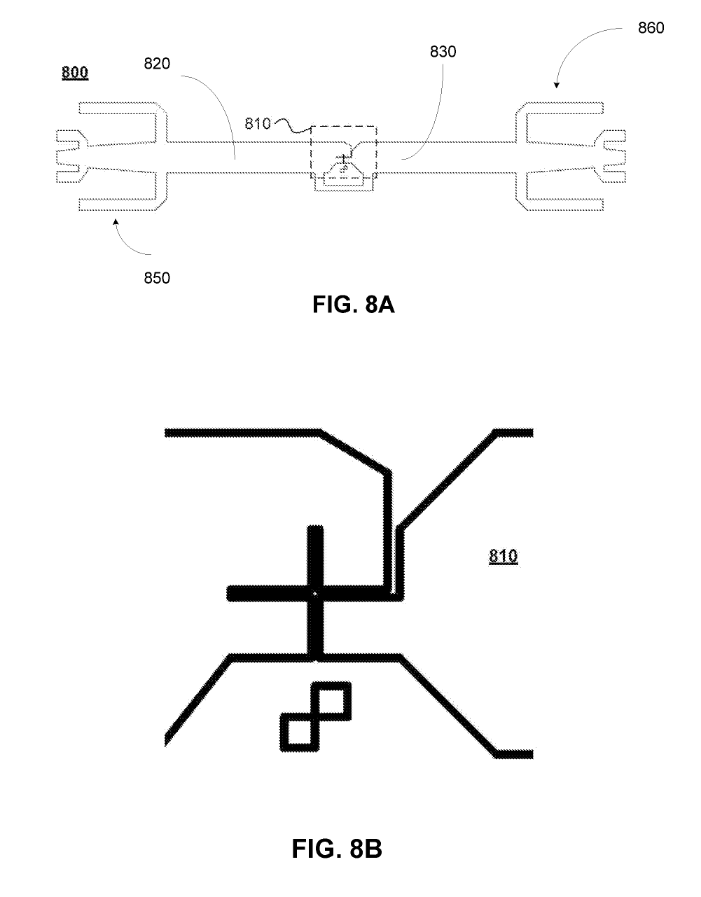

FIG. 7A illustrates a generally square-shaped antenna element arrangement 700 with two elongated rectangular slots 720 and 730 (first and second rectangular slots) near the center of antenna element arrangement 700. In an embodiment, antenna element arrangement 700 has a width and height of 2.705″ and 3″ (inch), respectively. A portion 710 is illustrated in detail in FIG. 7B, which shows a square-shaped island of antenna material in the first rectangular slot. The second rectangular slots includes two smaller square-shaped islands of antenna material within the perimeter of the slots. The two square-shaped islands of antenna material are coupled at a corner. Portion 710 includes a die-mount location for antenna element arrangement 700. The antenna elements of arrangement 700 constitute a so-called “patch” antenna. In the dipole antenna arrangements described above, the antenna elements are formed by metalizations of some sort (copper, silver, aluminum, etc.) on an insulating surface of a substrate. In a patch antenna, such as shown in the FIG. 7A and FIG. 7B embodiment, the antenna element is the entire surface such as surface 740 shown in FIG. 7A. Rectangular portions 720 and 730 actually represent a lack of metal. These “cut out” or “slot” portions tune the antenna as needed to obtain resonance in a desired band of operation and to impedance match the antenna to the IC with which it is to be used. A preferred fabrication of this patch antenna arrangement is copper on the surface of FR4 pc board. Other types of metal surface and underlying substrates can be used. Resonance is in large part determined by the size of rectangular portions 720 and 730. This particular antenna element arrangement is particularly well suited to be placed beneath the keyboard surface of a laptop computer so as to form a built in RFID tag for tracking the computer's location, logging it in for service, etc.

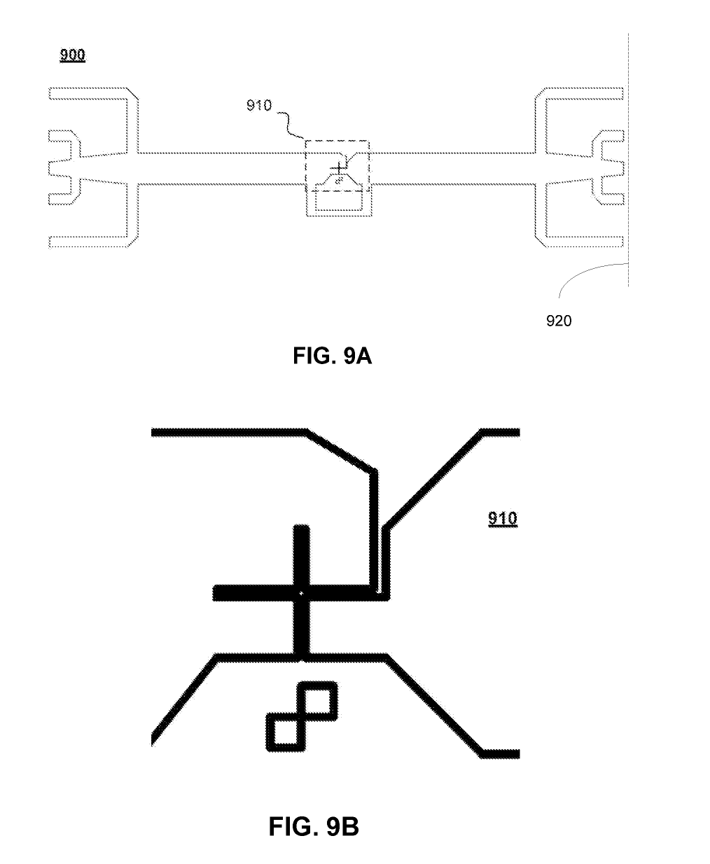

FIG. 8A illustrates an embodiment of a single dipole antenna element arrangement 800. This embodiment has a central bar-shaped portion including two arms 820, 830 extending away from a central location 840. Near the end of each arm are two pairs of U-shaped portions. The U-shape portions straddle the arm such that they form a pitchfork-like shaped antenna portion, referred to as a “trident”. Thus there is a first “trident” arrangement 850 at the left side of the figure and a second “trident” arrangement 860 at the right side of the figure. Antenna element arrangement 800 also includes a third U-shaped portion that connects the two arms, bypassing a die-mount location. A portion 810, shown in detail in FIG. 8B, shows the junction of the two arms where the IC die-mount location is located. The antenna element arrangement 800 is particularly well-suited for use in 900 MHz passive RFID tag applications. The arrangement shown in this embodiment falls into the general class of device and antenna arrangements known in the art as “1×4” because of their general overall dimensions of 1 inch by 4 inches. The entire arrangement has an effective electrical length of ½ wavelength at the intended operating frequency, usually corresponding to the center of the band in which it is intended to operate. The central portion, shown enlarged in FIG. 8B, is constructed an arranged to obtain the desired electrical length of dipole and to provide impedance matching from the dipole antenna to the RF ports of whatever IC it is used with.

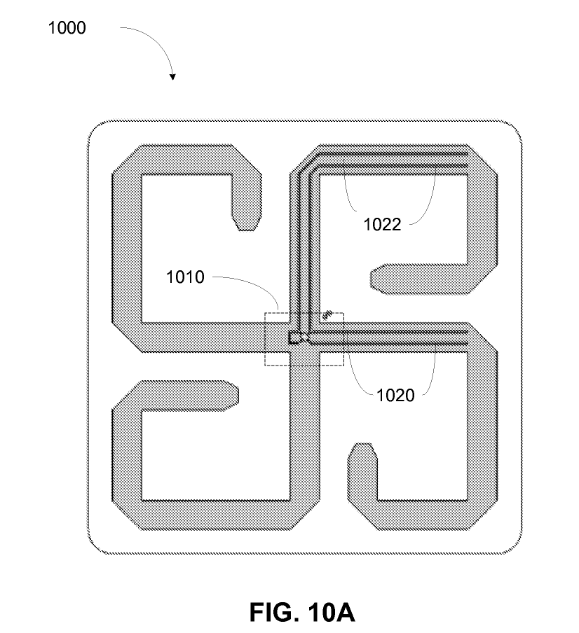

FIG. 9A illustrates an embodiment of an antenna element arrangement 900 that is generally similar to arrangement shown in FIG. 8. In antenna element arrangement 900, the tips of all pitchfork-shaped portions are flushed at an edge 920 (unlike arrangement 800). A detailed view of portion 910 is shown in FIG. 9B.

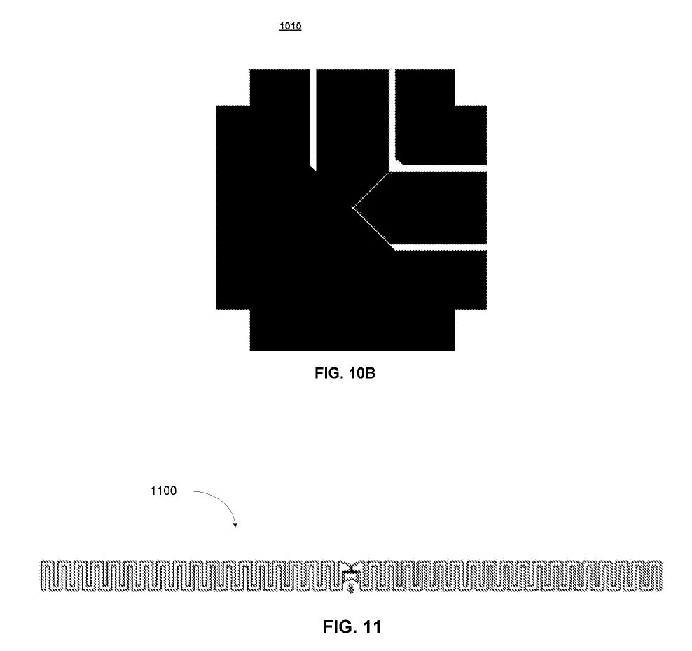

FIG. 10 illustrates an embodiment of an antenna element arrangement 1000. Arrangement 1000 has four arms extending from a center of antenna element arrangement 1000 to form a cross-shaped portion with an end of each arm further having three series connected rectangular segments that consecutively curve (at right angle with respect to the previous segment) in a clockwise direction. In embodiments, the arms may spirally extend from the center in a circular or smooth angular fashion. The corner or elbow between two of the rectangular segments is spliced, meaning the corner is removed (a triangular shaped portion is removed). Even though antenna 1000 is shown to have spliced corners, in another embodiment the corner or elbow is not spliced. For example, each corner may be square-shaped or partially rounded. Two of the arms have a pair of slots 1020 and 1022, respectively that start from the center of antenna element arrangement 1000 and run along the axis of the respective arm. These slots are constructed and arranged to cause the antenna to resonate at the desired frequencies and to provide an impedance match to an IC driving the antenna and receiving signals from it. A detailed view of portion 1010 is shown in FIG. 10B, which includes a die-mount location. The arrangement shown in this embodiment is particularly well suited for plastic applications, such as, for example, an animal ear tag.

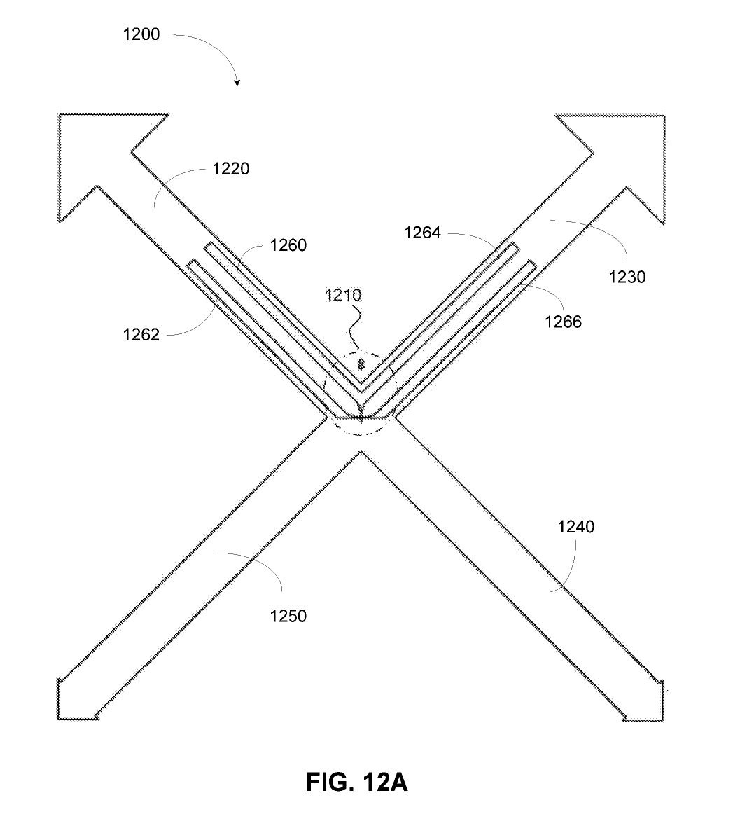

FIG. 11 illustrates an embodiment of an antenna element arrangement 1100 that is formed by two square wave-shaped portions joined at a central location. Each square wave-shaped portion has approximately 18 sinusoidal cycles. Other number of cycle could also be employed. This particular arrangement is particularly well suited for plastic applications. For example, this arrangement can be utilized in a long and narrow RFID tag affixed to a plastic CD case to monitor the location and status of a CD contained therein.

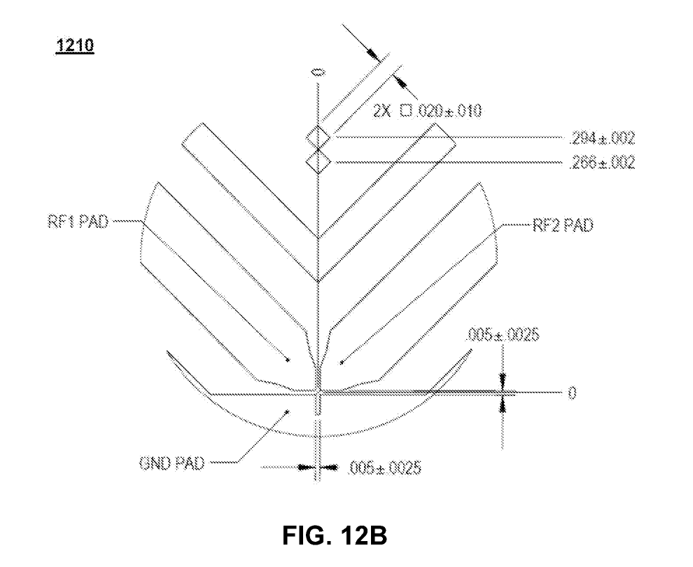

FIG. 12A shows “plus”-sign or cross-shaped antenna element arrangement 1200 (depending on the angle at which antenna element arrangement 1200 is viewed), according to embodiments of the present invention. Antenna element arrangement 1200 has four arms 1220, 1230, 1240 and 1250 radially extending from a center area 1210, enlarged in FIG. 12B. Each arm has a generally arrowhead-shaped end. Arm 1220 has a pair of gaps 1260, 1262 and arm 1230 has a pair of gaps 1264, 1266. These gaps extend along the respective arm, where the material of antenna the antennal elements is not present. Central region 1210 has a die-mount position, for an IC die having four contact pads. Each contact pad of the die is coupled to a respective arm 1220, 1230, 1240, 1250. This particular antenna element arrangement is particularly well suited for wood applications. For example, an RFID tag having this antenna element arrangement might be used as a read only tag on a wooden pallet to track the contents of a particular pallet. The dimensions shown in FIG. 12B are merely exemplary. Other dimensions, as appropriate can be used.

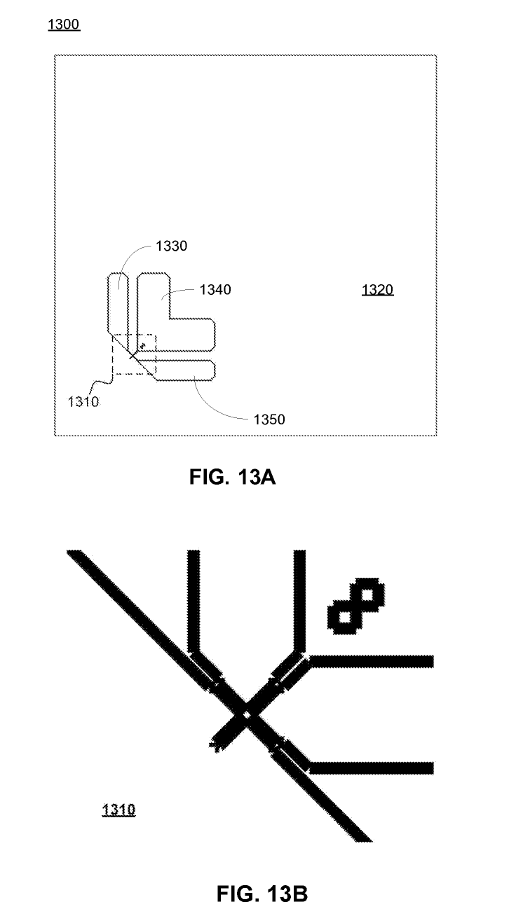

FIG. 13A illustrates an embodiment of an antenna element arrangement 1300. The antenna elements of arrangement 1300 constitute a so-called “patch” antenna. In the various dipole antenna arrangements described above, the antenna elements are formed by metalizations of some sort (copper, silver, aluminum, etc.) on an insulating surface of a substrate. In a patch antenna, such as shown in FIG. 13A, the radiating antenna element is formed by the entire surface such as metalized surface 1320 shown in FIG. 13A. Portions 1330, 1340 and 1350 are cut-out and represent a lack of metal. These “cut out” or “slot” portions tune the antenna as needed to obtain resonance in a desired band of operation and to impedance match the antenna to the IC with which it is to be used. A preferred fabrication of this patch antenna arrangement is copper on the surface of FR4 pc board. Other types of metal surface and underlying substrates can be used. Resonance is in large part determined by the size of portions 1330, 1340 and 1350. This particular antenna element arrangement is known as a “steeler” in that it is particularly well suited to be used in a cargo RFID tag. It is also categorized in the general category of 4×4 tags because of its general overall dimension of 4 inches by 4 inches.

Antenna element arrangement 1300 has a die mount location that is positioned in a corner quadrant of antenna element arrangement 1300. Portions 1330, 1340 and 1350 overlap a die-mount position, which is shown in detail in FIG. 13B, at portion 1310. Antenna element arrangement 1300 is generally square-shaped. A preferred material for the substrate is PET. The radiating surface 1320 can be fabricated from copper or other suitable metals such as silver, aluminum and other materials. In FIG. 13B, portions 1360, 1362, 1364, 1366, 1368, 1370 and 1372 constitute non-metalized regions.

FIG. 13C illustrates schematically an IC die 1380 having RF bumps 1382 and 1384 and ground bumps 1386 and 1388. Generally bumps 1380, 1382, 1384 and 1386 are made of gold, but other suitable metals can be used. The bumps of IC die 1380 communicate with respective portions of antenna element arrangement 1300 when the antenna and IC die are properly placed with respect to each other at region 1310.

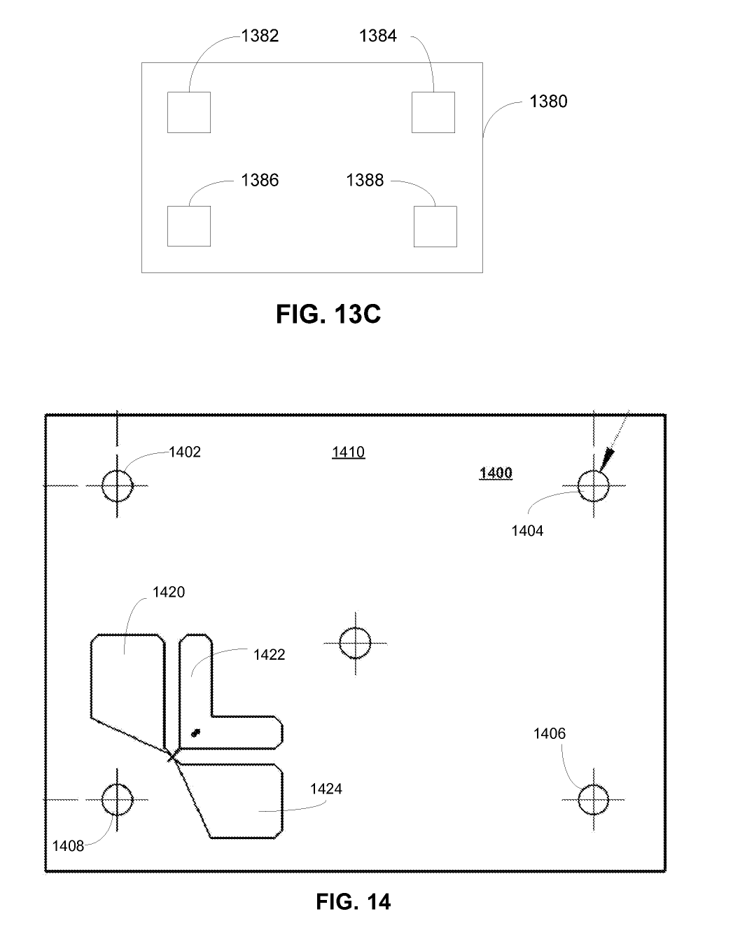

FIG. 14A illustrates an embodiment of an antenna element arrangement 1400 that is generally similar to antenna element arrangement 1300 of FIG. 13A. This arrangement also constitutes a patch antenna in that surface 1410 is a metallization that radiates or receives a signal. Antenna element arrangement 1400 is rectangular-shaped and further includes four generally circular slots 1402, 1404, 1406, 1408, one near each corner and another generally circular slot 1410 near the center of the element arrangement. The overall outside dimensions of this particular arrangement are approximately 2.75 inches by 3.75 inches. Portions 1420, 1422 and 1424 are regions of no metallization and overlap a portion whereat the antenna arrangement is coupled to bumps of an IC die.

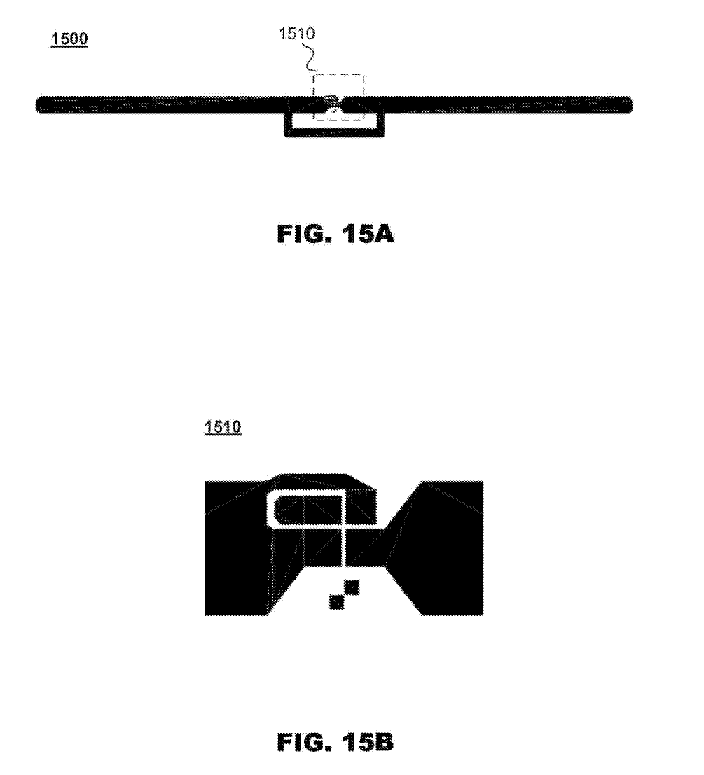

FIG. 15A illustrates an antenna element arrangement 1500. Antenna element arrangement 1500 has a first arm and a second arm extending in opposite directions from a central die-mount position. The central die-mount position is formed by a cross-shaped slot. The cross-shaped slot forms four separate pads, in which an IC die may be mounted. A U-shaped portion has ends coupled respectively to the first arm and second arm, creating a bypass around the die-mount location. A detailed view of portion 1510 is shown in FIG. 15B.

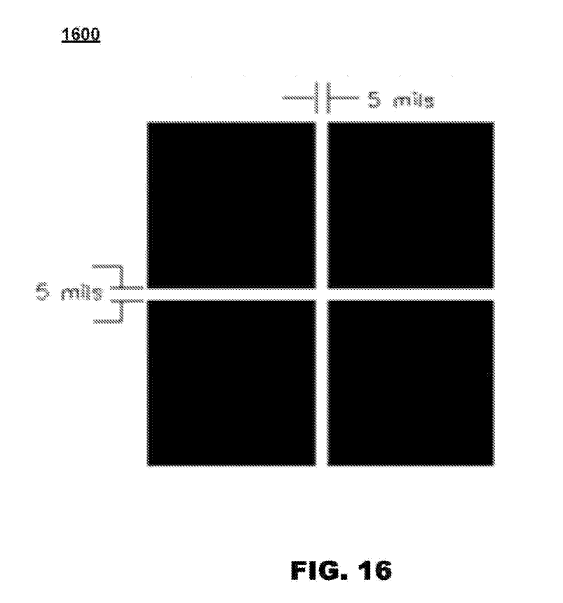

FIG. 16 shows exemplary dimensions of cross-shaped slot of antenna element arrangement 1510 that forms four die mounting pads. As shown, the vertical and horizontal slots have a dimension of approximately 5 mils with a tolerance of ±1 mil. The dimensional configuration of the slot shown in FIG. 16 may also be employed in any antenna element arrangements described or to be described herein.

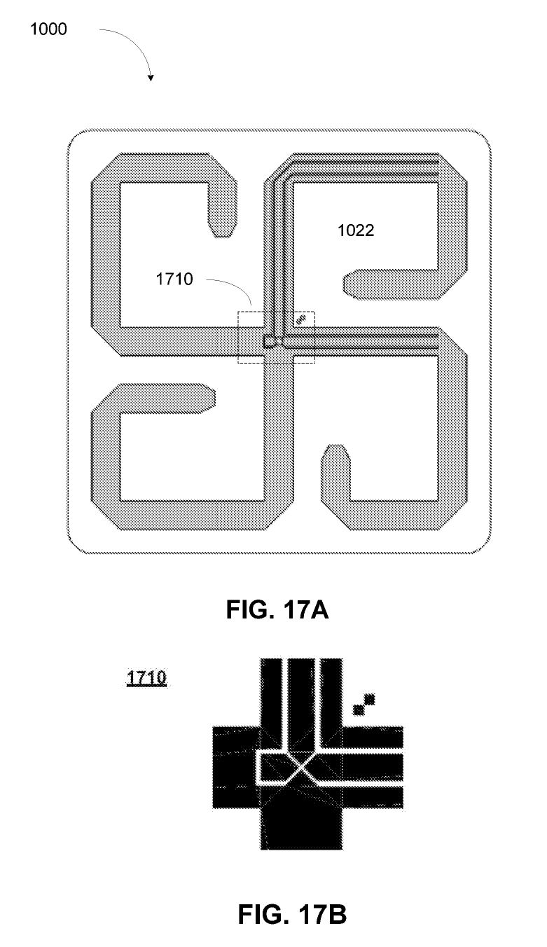

FIG. 17A illustrates an antenna element arrangement 1700 that is generally similar to antenna element arrangement 1000 of FIG. 10A. A central die-mount portion 1710, as shown in FIG. 17B, includes a cross-shaped slot at the center of antenna element arrangement 1700. The cross-shaped slot is also coupled to an extension slot that forms an island of antenna material having a square shape with one side of the square being arrow-shaped. This particular arrangement is particularly well suited for use in RFID animal tags such as those clipped to a cow's ear.

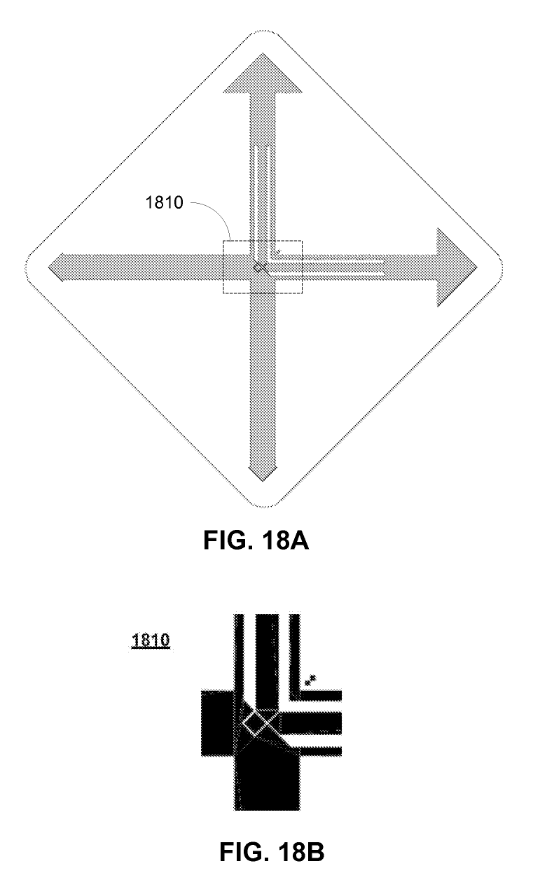

FIG. 18A illustrates an antenna element arrangement 1800 that is generally similar to antenna element arrangement 1200 of FIG. 12A. Portion 1810, as shown in FIG. 18B, includes a cross-shaped slot at the center of antenna element arrangement 1800. The cross-shaped slot is also coupled to an extension slot that forms a square-shaped island of antenna material. This particular arrangement is particularly well suited for wood applications, such as, for example, affixing to a wood pallet for tracking goods on the pallet.

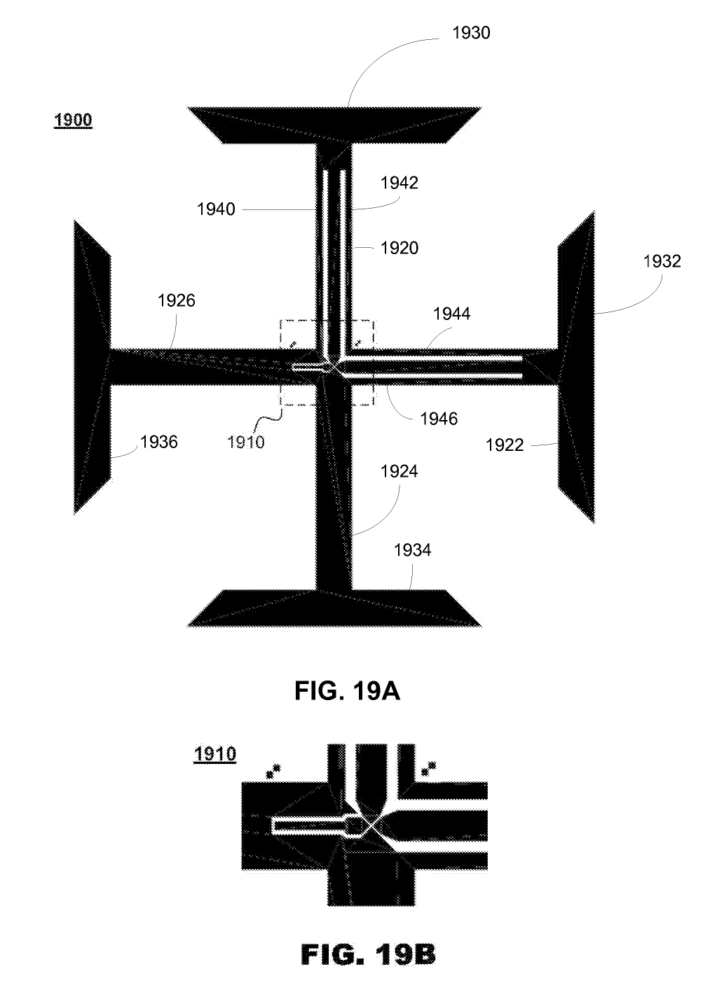

The embodiment shown in FIG. 19A is a dual dipole antenna element arrangement 1900. This arrangement has four arms 1920, 1922, 1924, 1926 radially extending from a central region 1910, enlarged in FIG. 19B. Each of the arms has a trapezoidal-shaped end portion 1930, 1932, 1934, 1936, respectively. Each arm is coupled to a center of the short parallel side of the respective trapezoid. The arms and trapezoidal portions are formed by metalizations on a non-conductive portion of a substrate, such as pc board. The metalizations can be copper, silver, aluminum or other suitable metal. Arm 1920 has slots 1940 and 1942 formed therein. Arm 1922 has slots 1944 and 1946 formed therein. These slots represent a lack of metallization and are used for impedance matching and tuning the antenna to resonance. Central portion 1910 of antenna element arrangement 1900, as shown in FIG. 19B, also includes a contoured-slot 1950 having a shape of a cross and a spade-shaped (shovel-shaped) island of antenna material extending along the axis of one of the arm. In general, this antenna element arrangement falls into the general class of tags known as 4×4 because of its approximate outside dimensions of 4 inches by 4 inches. Connection to the IC die is made in central region 1910.

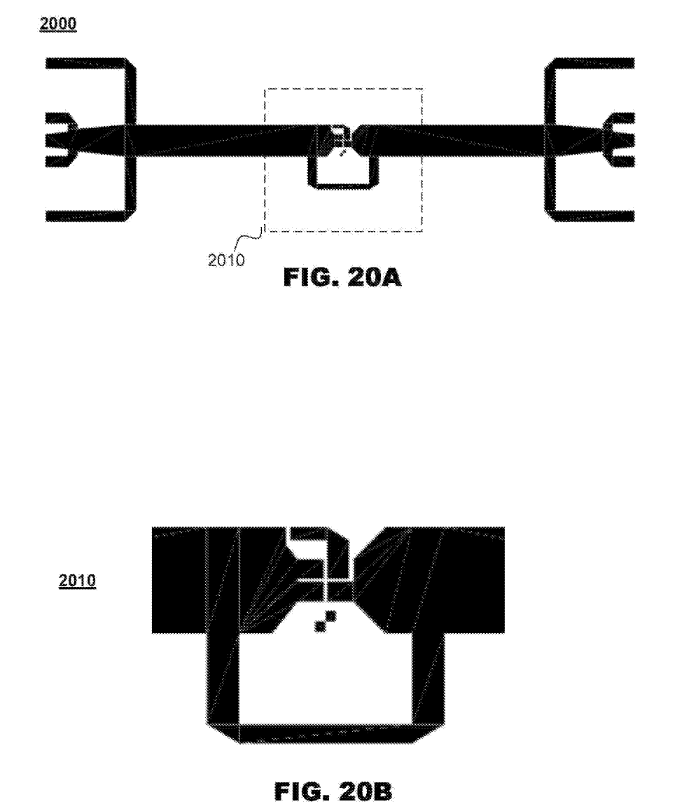

FIG. 20A illustrates an antenna element arrangement 2000 that is generally similar to the element arrangement of arrangement 800 of FIG. 8A. Portion 2010, as shown in FIG. 18B, includes a cross-shaped slot at the center of antenna element arrangement 2000. The cross-shaped slot separates the center of antenna portion 2000 into four area. Each areas. Each area acts as an IC pad for the mounting of an IC die. One of the pads is L-shaped.

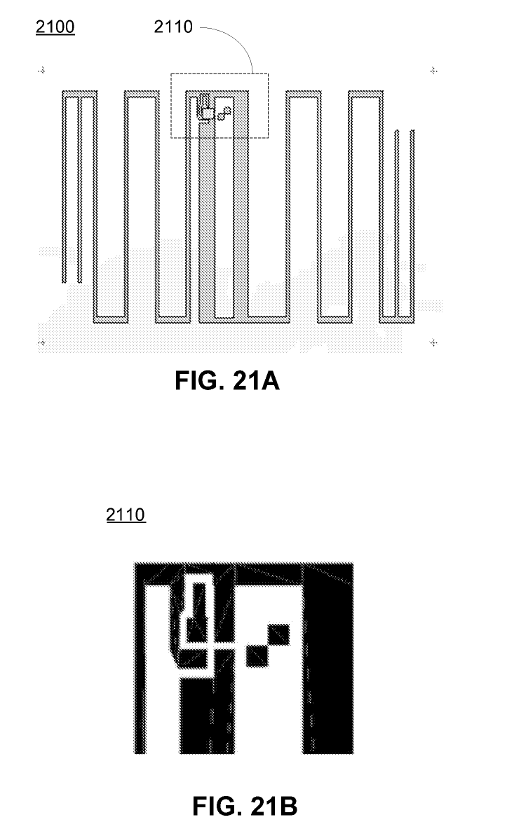

FIG. 21A shows an embodiment of a single dipole antenna element arrangement 2100. Arrangement 2100 has a squared-serpentine element arrangement. First and second ends of the serpentine element arrangement have U-shaped ends. Antenna element arrangement 2100 also includes a L-shaped portion. Each end of the L-shaped portion is attached near a central portion 2110 of antenna element arrangement 2100 which is shown enlarged in FIG. 21B. A die mount position is located on the L-shaped portion, which is illustrated in detail by portion 2110, shown in FIG. 21B. This particular antenna element arrangement is particularly useful for pharmaceutical applications because it can be easily is tuned for the dielectric constants present in a plastic environment and its dimensions allow an ease of fit on vials, such as those used to contain of medicine.

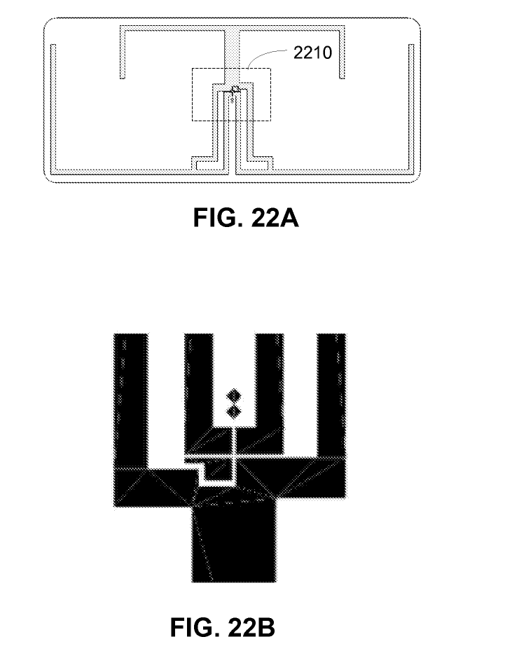

FIG. 22A illustrates another embodiment of an antenna element arrangement 2200. This arrangement is particularly well suited for bag tag applications, such as, for example, airport luggage. Antenna element arrangement 2200 has an interior portion, a first U-shaped portion, a second U-shaped portion, and a third U-shaped portion. The interior portion has a shape similar to a tuning folk. A first end of the interior portion is coupled to a center inside-portion of the first U-shaped portion. A second end of the interior portion is coupled to second U-shaped portion, near the proximal end (the intersection between the interior portion and the first and third U-shaped portions) of second the U-shaped portion. A third end of the interior portion is coupled to the third U-shaped portion, also near the proximal end. A die-mount position is located in a portion 2210, as shown in detail in FIG. 22B The die-mount position is formed by the junction of interior portion, the end of second U-shaped portion, and the end of third U-shaped portion.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A radio frequency identification (RFID) tag, comprising:
a substrate;
an integrated circuit (IC) mounted to the substrate; and
an antenna formed by antenna element metalizations on the substrate and connected to the IC, at least one of the metalizations having a shape that allows it to have a physical length smaller than its electrical length at a frequency of operation of the RFID tag, the antenna including at least one metallization constructed and arranged to provide impedance matching between the antenna and a port of the IC.

2. A tag according to claim 1 wherein the at least one metallization that provides impedance matching is also constructed an arranged to control the resonant frequency of the antenna.

3. A tag according to claim 1 wherein at lest one antenna element is constructed and arranged to have an undulating shape.

4. A tag according to claim Al wherein at lest one antenna element is constructed and arranged to have an undulating shape with a pitch that is greater than a thickness of metallization of the element.

5. A tag according to claim 1 further comprising a feed metallization carrying signals between an antenna element and the IC.

6. A tag according to claim 5 wherein the impedance matching metallization is coupled to the feed metallization.

7. A tag according to claim 1 wherein at lest one antenna element is constructed and arranged to have an undulating substantially square shape.

8. A tag according to claim 1 wherein at lest one antenna element is constructed and arranged to have a “trident” shape.

9. A tag according to claim 8 wherein at lest one antenna element constructed and arranged to have a “trident” shape is constructed and arranged to have a resonant frequency in a desired band of operation.

10. A radio frequency identification (RFID) tag, comprising:
a substrate having a non-conductive surface;
an integrated circuit (IC) mounted to the substrate; and
an antenna formed by an antenna element metallization on the substrate and connected to the IC, the metallization covering a substantial portion of the non-conductive surface of the substrate and having at least one slot portion constituted by a region of no metallization, the slot portion being constructed and arranged to provide impedance matching between the antenna and a port of the IC.

11. A tag according to claim 10 wherein the cut out portion that provides impedance matching is also constructed an arranged to control the resonant frequency of the antenna.

12. A tag according to claim 10 wherein the antenna element metallization has two slot portions that provides impedance matching is also constructed an arranged to control the resonant frequency of the antenna.

13. A tag according to claim 10 wherein at least one slot portion is “L” shaped.

14. A tag according to claim 10 wherein at least two slot portions are “L” shaped.

15. A tag according to claim 10 wherein the substrate has bore holes therein.

16. A radio frequency identification (RFID) tag, comprising:
a substrate;
an integrated circuit (IC) mounted to the substrate; and
an antenna formed by at least one metallization on the substrate and connected to the IC, at least one of the metalizations having a shape that allows it to have a physical length different from its electrical length at a frequency of operation of the RFID tag, the antenna including at least one metallization constructed and arranged to provide impedance matching between the antenna and a port of the IC.

17. The tag of claim 16, wherein the antenna has a shape substantially as shown in FIG. 1.

18. The tag of claim 16, wherein the antenna has a shape substantially as shown in FIG. 2.

19. The tag of claim 16, wherein the antenna has a shape substantially as shown in FIG. 4A.

20. The tag of claim 16, wherein the antenna has a shape substantially as shown in FIG. 5A.

21. The tag of claim 16, wherein the antenna has a shape substantially as shown in FIG. 6A.

22. The tag of claim 16, wherein the antenna has a shape substantially as shown in FIG. 7A.

23. The tag of claim 16, wherein the antenna has a shape substantially as shown in FIG. 8A.

24. The tag of claim 16, wherein the antenna has a shape substantially as shown in FIG. 9A.

25. The tag of claim 16, wherein the antenna has a shape substantially as shown in FIG. 10A.

26. The tag of claim 16, wherein the antenna has a shape substantially as shown in FIG. 11.

27. The tag of claim 16, wherein the antenna has a shape substantially as shown in FIG. 12A.

28. The tag of claim 16, wherein the antenna has a shape substantially as shown in FIG. 13A.

29. The tag of claim 16, wherein the antenna has a shape substantially as shown in FIG. 14.

30. The tag of claim 16, wherein the antenna has a shape substantially as shown in FIG. 15A.

31. The tag of claim 16, wherein the antenna has a shape substantially as shown in FIG. 17A.

32. The tag of claim 16, wherein the antenna has a shape substantially as shown in FIG. 18A.

33. The tag of claim 16, wherein the antenna has a shape substantially as shown in FIG. 19A.

34. The tag of claim 16, wherein the antenna has a shape substantially as shown in FIG. 20A.

35. The tag of claim 16, wherein the antenna has a shape substantially as shown in FIG. 21A.

36. The tag of claim 16, wherein the antenna has a shape substantially as shown in FIG. 22A.
